(19) United States
(12) Patent Application Publication
(10) Pub. No.: US 2022/0030840 A1
(43) Pub. Date: Feb. 3, 2022

(54) FISHING LURE

(71) Applicant: Isaac C. F. Payne, Frisco, TX (US)

(72) Inventor: Isaac C. F. Payne, Frisco, TX (US)

(21) Appl. No.: 17/387,514

(22) Filed: Jul. 28, 2021

Related U.S. Application Data
(60) Provisional application No. 63/057,561, filed on Jul. 28, 2020.

(51) Int. Cl. A01K 85/14

(52) U.S. Cl. CPC A01K 85/14

(57) ABSTRACT

One or more embodiments of a device for fishing or luring fish are disclosed. The fishing lure includes a corrugated sheet, an accessory, and a hook. The corrugated sheet includes a first end area, a second end area, at least one peak and at least one trough. The at least one peak and at least one trough is between the first end area and the second end area in the first direction. The corrugated sheet defines a first line inlet between the first end area and the second end area and defines a second line inlet between the first end area and the second end. The corrugated sheet further defines an accessory inlet in the first end area. The accessory is attached to the corrugated sheet via the accessory inlet. The hook is attached to the accessory.

### CROSS REFERENCE TO RELATED APPLICATIONS

This application claims priority to U.S. Provisional Patent application No. 63/057,561, which was filed Jul. 28, 2020, which is incorporated in its entirety.

### FIELD OF THE DISCLOSURE

The present invention relates to devices for fishing and luring fish.

### BACKGROUND

For thousands of years, humans have turned to fishing for both a means to survive and a means of enjoyment. Over the course of time, specialized fishing techniques and equipment have been developed, aiding humans in their quest to catch a trophy-sized creature. Of the equipment developed, the modern “lure” is one of the most important.

There are several classes and types of fishing lures, as different fish species have different sensory characteristics and stimuli, but often the basic principles behind a lure's structure are the same. Perhaps the most important principles are the lure's ability to attract the attention of the fish and entice the fish to bite the lure. A combination of reflected light and movement can cause a predatory sensory reaction within a fish's brain, giving the fish the desire to bite the lure. If a lure does not reflect light to a wide range of directions, the chances that the lure will be seen by a fish are diminished. Likewise, if a fish sees the reflection of light from a lure but does not sense the proper water movements, the fish is less likely to pursue the lure.

Previous attempts have been made to create lures that draw the attention of a fish through reflected light and lateral movement. However, in previous lures the area in which light is reflected has been limited and the movement of the lure has not been very life-like and alluring to a fish because the lateral movement of the lure is limited. Accordingly, previous lures have limited effectiveness in attracting the attention of fish and enticing the fish to bite the lure. Fishing lures that use blades which are flat or with a single curve to the surface of the blade only allow a line tie connector to rotate about 90 degrees. This limits that sideways movement of the lure in the water when pulled through the water.

### SUMMARY

One or more embodiments are provided below for a device for fishing or luring fish. The device may include a corrugated sheet, an accessory, and a hook. The corrugated sheet may include a first end area, a second end area, at least one peak and at least one trough. The at least one peak and at least one trough may be between the first end area and the second end area in the first direction. The corrugated sheet may define a first line inlet between the first end area and the second end area and define a second line inlet between the first end area and the second end area the first end area and the second end area. The corrugated sheet may further define an accessory inlet in the first end area. The accessory may be attached to the corrugated sheet via the accessory inlet. The hook may be attached to the accessory.

The device may provide significant advantages over the devices known in the art. The device may have improved mobility side to side when pulled through in the water compared to other fishing lures due to the shape of the corrugated sheet and the ability of a line-tie connector connected through the first and second line inlets to rotate more than is possible with previous fishing lures and accessories.

Other advantageous features as well as other aspects and advantages of the invention will be apparent from the following description and the appended claims.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 shows an example side view of a fishing lure.

FIG. 2 shows an example top view of the fishing lure's corrugated sheet with a line-tie connector and an accessory connector attached.

FIG. 3 shows an example side perspective of the corrugated sheet with a line-tie connector attached to the body.

FIG. 4 shows an example side view of a second fishing lure.

### DETAILED DESCRIPTION

In the Summary above and in this Detailed Description, the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “coupled to” as used herein may mean a direct or indirect connection via one or more components.

Referring now to the drawings and the following written description of the present invention, it will be readily understood by those persons skilled in the art that the present invention is susceptible to broad utility and application. Many embodiments and adaptations of the present invention other than those herein described, as well as many variations, modifications, and equivalent arrangements will be apparent from or reasonably suggested by the present invention and the detailed description thereof, without departing from the substance or scope of the present invention. This disclosure is only illustrative and exemplary of the present invention and is made merely for purposes of providing a full and enabling disclosure of the invention.

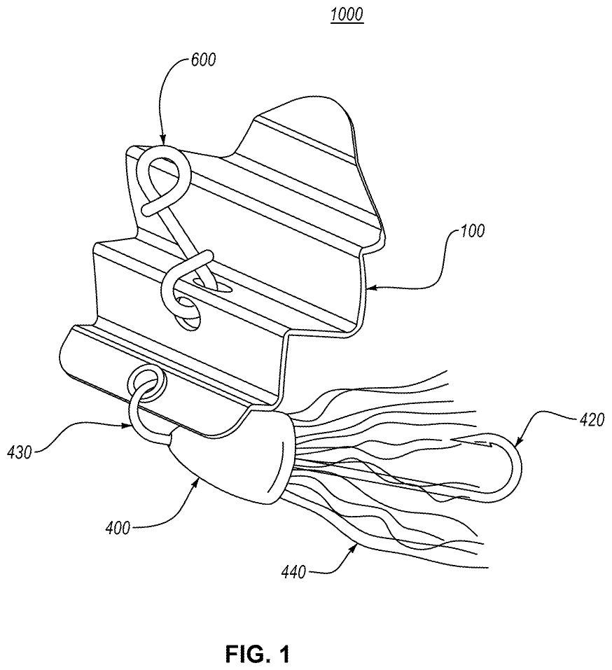

FIG. 1 shows a side view of a fishing lure 1000. The fishing lure 1000 may include a corrugated sheet 100, a line-tie connector 600, an accessory connector 430, an accessory 400 with accessory tails 440, and a hook 420. The accessory 400 may be attached to the corrugated sheet 100 by the accessory connector 430. The accessory 400 may be attached to the hook 420. The hook 420 may be attached in such a way as to maintain its orientation relative to the accessory 400. The hook 420 may be used to hook a fish and pull the fish out of the water. The hook 420 may include a metal or other durable material. In some example embodiments, the fishing lure 1000 may include multiple accessories 400 and/or multiple hooks 420. The lure 1000 may include accessory tails 440 which obscure the hook and make the lure more visually appealing to a fish such as a bass. When a user pulls on the line-tie connector 410 (e.g., via a fishing line and fishing poll), the corrugated sheet 100 and the accessory 400 may orient at an acute angle with the accessory 400 dragging behind the corrugated sheet 100. As the corrugated sheet 100 is pulled through the water the corrugated sheet may be moved back and forth by the water causing the accessory to also move back and forth through the water in such a way that to a fish the lure 1000 looks like swimming prey.

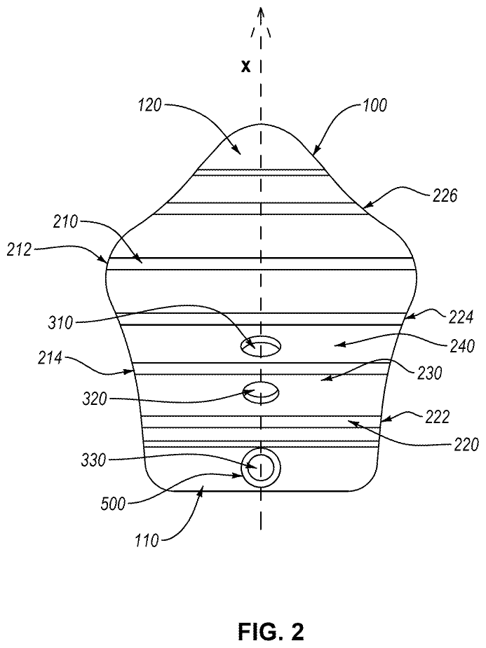

FIG. 2 is a top view of the corrugated sheet 100, the accessory connector 430, and the line-tie connector 410. The corrugated sheet 100 may have a wave-like or undulating shape and include a first end area 110, at least one peak 210, at least one trough 220, and a second end area 120. The first end area 110 may include an accessory-receiving inlet 330 through which the connector ring 430, as shown in FIG. 1, may attach. A first direction “X” is the direction from the first end area 110 to the second end area 120. A first trough 222 may be immediately proximate to the first end area 110 in the first direction “X” and a first peak 212 may be the first peak immediately proximate to the first trough 222 in the first direction “X”. A second trough 224 may be immediately proximate to the first peak 212 in the first direction “X”. A second peak 214 may be immediately proximate to the second trough 224 in the first direction “X”. A third trough 226 may be immediately proximate to the second peak 214 in the first direction “X”. The second end area 120 may be immediately proximate to the third trough 226 in the first direction “X”. In different example embodiments, the corrugated sheet 100 may include different numbers of peaks 210 and troughs 220. For example, the corrugated sheet may include one peak 210 and two troughs 220.

A first mid portion 230 may be located between the first trough 222 and the first peak 212. The first mid portion 230 may extend from the first trough 222 to the first peak 212 in the first direction “X”. A second mid portion 240 may be proximate to the first peak 212 in the first direction “X” and extend from the first peak 212 to a second trough 224. A first line-receiving inlet 310 may be located in the first mid portion 230 and a second line-receiving inlet 320 may be located in the second mid portion 240. The line-tie connector 410 may be attached to the corrugated sheet 100 through the first line-receiving inlet 310 and the second line-receiving inlet 320. Optionally, a user may forgo use of the line-tie connector 410 and connect a line directly to the corrugated sheet 100 through the first line-receiving inlet 310 and the second line-receiving inlet 320.

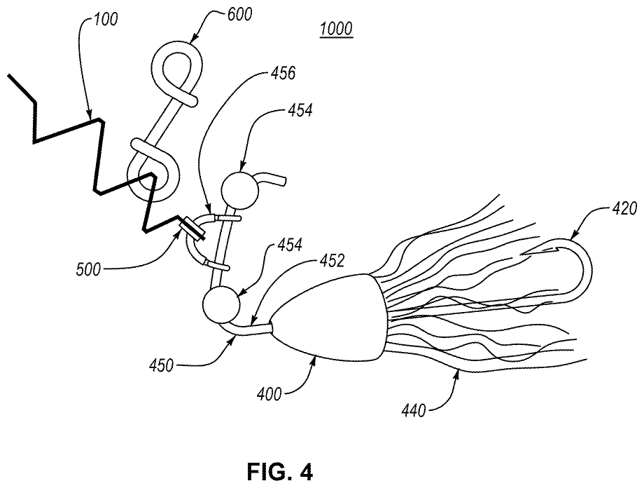

The corrugated sheet 100 may include a grommet 500 inserted into the accessory inlet 330. The grommet 500 may act to protect the corrugated sheet 100 from damage from pulling the fish out of the water after a fish bites the hook 420, as shown in FIG. 1. Force from pulling the fish out of the water may go through a fishing line (not shown) to the line-tie connector 600 as shown in FIGS. 1, 3, and 4, the corrugated sheet 100, the accessory 400, and hook 420. Because there may be two points of contact between the line-tie connector 600 and the corrugated sheet 100 and only one between the accessory 400 and the corrugated sheet 100, the corrugated sheet 100 may be more likely to be damaged by the connection to the accessory 400 when a fish is pulled out of the water using the fishing lure 1000. Thus, the grommet 500, as shown in FIG. 2 and FIG. 4, may be used to prevent or reduce this damage. The grommet 500 may include metal, plastic or other durable materials that may be used to disperse force. The grommet 500 may be a rivet or other similar structure that is inserted through the accessory inlet 330 and is secured by its own structure in the accessory inlet 330.

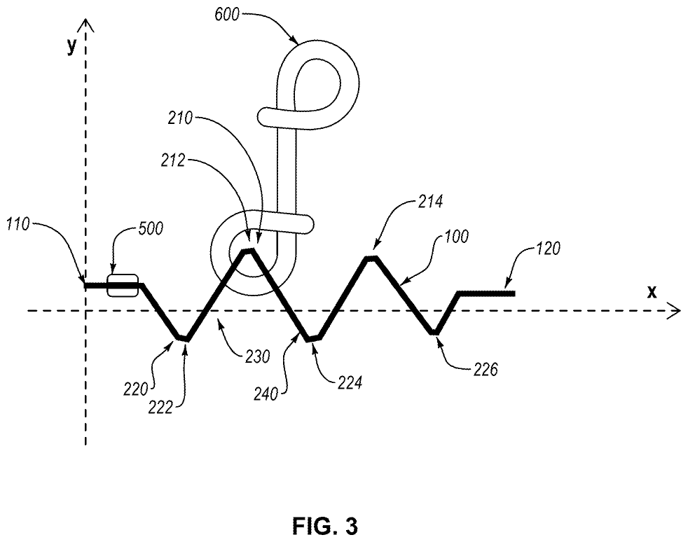

FIG. 3 shows a side perspective of the corrugated sheet 100. The first end area 110 may extend parallel to the first direction “X”. The second end area 120 may extend parallel to the first direction “X”. The second direction “Y” may be perpendicular to the first direction “X”. The peaks 210 may be local maxima in the second direction “Y”. A local maxima is a location where the material on either side is lower in the direction “Y”. The troughs 220 may be local minima in the second direction “Y”. A local minima is a location where material on either side is higher in the “Y” direction. Accordingly, from the perspective of the first direction “X” and second direction “Y”, the first mid portion 230 may be an inclined surface and the second mid portion 240 may be a declined surface. The first mid portion 230 may be inclined at about a 45-degree angle relative to the first direction “X”. The second mid portion 240 may be declined at about a 45-degree angle relative to the first direction “X”. The shape of the peaks 210 may be a sharp curve of about 90 degrees. However, other angles and shapes are also possible for the peaks 210.

The corrugated sheet 100 may include metal, plastic, or other durable material suitable for pulling a fish from the water. The metal, plastic, or other durable material may form a body of the corrugated sheet 100. The corrugated sheet 100 may include a material capable of reflecting or refracting light underwater. For example, the corrugated sheet 100 may include a material that reflects at least 60% of incident light that contacts the corrugated sheet 100. In some embodiments, the corrugated sheet 100 may include multiple materials. For example, the corrugated sheet 100 may include a metal that is coated with a reflective paint. In some example embodiments, the corrugated sheet 100 may include a single sheet of metal, with a thickness of about 1 mm, bent or pressed into the wave-like shape to form the peaks 210 and troughs 220.

In some examples, the peaks 210 may be of uniform shape and dimensions (e.g., same curvature, same height in the second direction). In other example embodiments, the peaks 210 may differ in shape, and dimensions. In some examples, the troughs 220 may be of uniform shape and dimensions (e.g., same curvature, same height in the second direction). In other example embodiments, the troughs 220 may differ in shape and dimensions. In some examples, the first end area 110 and the second end area 120 may extend in the same plane. In other examples embodiments, the first end area 110 and the second end area may extend in different planes.

Advantageously, when the user pulls on the line-tie connector 600, the passing of the corrugated sheet 100 through the water may cause the corrugated sheet to rotate. This causes the lure to appear to move like prey of the fish swimming. The shape of the corrugated sheet 100 with at least one peak 210 and at least one trough 220 causes the rotating effect to be increased while decreasing the drag of the corrugated sheet 100.

The corrugated sheet 100 may reflect light from a single light source in many directions due to the shape of the corrugated sheet 100. This advantageously increases the likelihood that a fish will see the lure 1000. The area in which light is reflected from a single light source (such as the sun) may be increased by differentiating the shape and dimensions of the peaks 210 and the troughs 220 and by having the first end area 110 and the second end area 120 extend in different planes. For example, in selecting for a preferred field of light reflection, a user may prefer a corrugated sheet 100 with a first trough 222 that has different shape and dimensions to the second trough 224. In another example, in order to achieve a preferred reflective field of light at a specific water depth, a user may select a corrugated sheet 100 with peaks 210 and troughs 220 featuring specific shapes and dimensions for the preferred reflective field.

The placement of the first and second line-receiving inlet 310, 320 on opposite sides of the first peak 212 allows the line-tie connector 410 to move in a larger arch (about 170 degrees) in a plane perpendicular to the first direction “X” than would be possible if the first and second line-receiving inlets 310, 320 were on a flat surface. Advantageously, this greater rotational movement of the line-tie connector 410 relative to the corrugated sheet 410 causes the lure 1000 to move more side to side when being pulled through the water. The combination of this advantage with the increased movement and decreased drag caused by the shape of the corrugated sheet 100 cause the lure to appear more lifelike in its movements and more alluring for fish such as bass.

FIG. 4 shows an example side view of a second fishing lure 1000. The second fishing lure may be the same as the first fishing lure 1000 except the accessory connector 430 may be replaced with an accessory connection assembly 450. The accessory connection assembly 450 may include a shank 452 that extends out from the accessory tails 440 and curves upwards in the same plane that as the hook 420 curves in. The accessory connector assembly 450 may include stoppers 454 and an accessory connector 456 on the shank 452. The stoppers 454 may be fixed to the shank 452 such that they do not move under normal usage of the fishing lure 1000. The accessory connector 456 may pass around the shank 452 in at least one position (two are shown in FIG. 4 however one or more connections would work) between the stoppers 454 and be able to rotate around the shank 452. The shank 452 and the stoppers 454 may include metal and may be welded together or otherwise fixed together or be made of other durable materials that can be secured together. The accessory connector 456 may include a metal wire (or other durable material) wrapped around the shank 452 (and in some cases welded to itself around the shank 452). The accessory connector 456 should have sufficient strength to be used to pull a fish out of the water via its connection to the corrugated sheet 100. The accessory connector 456 may be able to move up and down on the shank 452 between the stoppers 454, thus making the movement of the fishing lure 1000 more jerky when changing direction. This jerky side to side motion can be more enticing to some fish and provides an advantage to the fishing lure 1000.

The accessory connection assembly 450 allows the corrugated sheet 100 to have additional freedom to move relative to the hook 420 by adding the point of rotation between the shank 452 and the accessory connector 456. This allows the fishing lure 1000 to have even greater lateral movement through the water when it is pulled through the water giving the fishing lure a more attractive look and allowing the corrugated metal 100 to reflect light in an even broader area with more enticing movements for fish to follow.

In one example embodiment the fishing lure 1000 may include a corrugated sheet 100, an accessory 400, and a hook 500. The corrugated sheet 100 may include a first end area 110, a second end area 120, at least one peak 210 and at least one trough 220. The at least one peak 210 and at least one trough 220 may be between the first end area 110 and the second end area 120 in the first direction “X”. The corrugated sheet 100 may define a first line inlet 320 between the first end area 110 and the second end area 120 and define a second line inlet 310 between the first end area 110 and the second end area 120. The corrugated sheet 100 may further define an accessory inlet 330 in the first end area 110. The accessory 400 may be attached to the corrugated sheet 100 via the accessory inlet 330. The hook 500 may be attached to the accessory 400. The fishing lure 1000 may further include a line-tie connector 600 attached to the corrugated sheet 100 through the first line inlet 320 and the second line inlet 310. The line-tie connector 600 may be attached to the corrugated sheet 100 such that the line-tie connector 600 is capable of rotating at least 170 degrees relative to the corrugated sheet 100 in a plane perpendicular to the first direction “X”. Each of the at least one peak 210 may be a local maximum in the second direction “Y” perpendicular to the first direction “X”. Each of the at least one trough 220 may be a local minimum in the second direction “Y”.

The corrugated sheet 100 may include a first sloped portion 230 and a second sloped portion 240. One of the at least one peak 210 may be between the first sloped portion 230 and the second sloped portion 240, as shown for example in FIG. 2. The first sloped portion 230 may have a positive slope relative to the first and second directions and the second sloped portion 240 has a negative slope relative to the first and second directions “X” and “Y”, respectively. The first sloped portion 230 may define the first line inlet 320 and the second sloped portion 240 may define the second line inlet 310. The first line inlet 320 and second line inlet 310 may be arranged and sized such that when the line-tie connector 600 is attached to the corrugated sheet 100 via the first line inlet 320 and second line inlet 310, the line-tie connector 600 is capable of rotating at least 170 degrees relative to the corrugated sheet 100 in a plane perpendicular to the first direction “X”.

The accessory 400 may include a shank 452 and an accessory connector 456, wherein the shank 452 is attached to the corrugated sheet 100 via the accessory connector 456, and wherein the accessory connector 456 is configured to rotate around the shank 452. The accessory connector 456 may connect to the shank 452 at multiple points. The fishing lure 1000 may further include a grommet 500 inserted in the accessory inlet 330.

In a second example embodiment the fishing lure 1000 may include a corrugated sheet 100, an accessory 400 and a hook 500. The corrugated sheet 100 may include at least one peak 210 and a plurality of troughs 220. The first peak 214 of the at least one peak 210 may be between a first trough 222 and a second trough 224 of the plurality of troughs 220. The corrugated sheet 100 may define a first line inlet 320 and define a second line inlet 310 between the first trough 222 and the second trough 224. The corrugated sheet 100 may further define an accessory inlet 330, where the first trough 222 is between the accessory inlet 330 and the first peak 214 in the first direction “X”. The accessory 400 may be attached to the corrugated sheet 100 via the accessory inlet 330. The hook 500 may be attached to the accessory 400.

Many different embodiments of the inventive concepts have been shown. A person of ordinary skill in the art will appreciate that the features from different embodiments may be combined or replaced with other features from different embodiments.

The device may provide significant advantages over the devices known in the art. The fishing lure 1000 may have improved mobility side to side when pulled through in the water compared to other fishing lures due to the shape of the corrugated sheet 100 and the ability of a line-tie connector 600 connected through the first and second line inlets to rotate more than is possible with previous fishing lures and accessories.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A fishing lure comprising;
a corrugated sheet including a first end area, a second end area, at least one peak and at least one trough, wherein the at least one peak and the at least one trough are between the first end area and the second end area in a first direction, wherein the corrugated sheet defines a first line inlet between the first end area and the second end area, and defines a second line inlet between the first end area and the second end area, wherein the corrugated sheet further defines an accessory inlet in the first end area;
an accessory attached to the corrugated sheet via the accessory inlet; and
a hook attached to the accessory.

2. The fishing lure of claim 1 further comprising:
a line-tie connector attached to the corrugated sheet through the first line inlet and the second line inlet.

3. The fishing lure of claim 2, wherein the line-tie connector is attached to the corrugated sheet such that the line tie connector is capable of rotating at least 170 degrees relative to the corrugated sheet in a plane perpendicular to the first direction.

4. The fishing lure of claim 1, wherein each of the at least one peak is a local maximum in a second direction perpendicular to the first direction, and each of the at least one trough is a local minimum in the second direction.

5. The fishing lure of claim 4, wherein the corrugated sheet includes a first sloped portion and a second sloped portion, wherein one of the at least one peak is between the first sloped portion and the second sloped portion, wherein the first sloped portion has a positive slope relative to the first and second directions and the second sloped portion has a negative slope relative to the first and second directions.

6. The fishing lure of claim 5, wherein the first sloped portion defines the first line inlet and the second sloped portion defines the second line inlet.

7. The fishing lure of claim 6, wherein the first line inlet and second line inlet are arranged and sized such that a line-tie connector attached to the corrugated sheet via the first line inlet and second line inlet is capable of rotating at least 170 degrees relative to the corrugated sheet in a plane perpendicular to the first direction.

8. The fishing lure of claim 1, wherein the accessory includes a shank and a connector, wherein the shank is attached to the corrugated sheet via the connector, and wherein the connector is configured to rotate around the shank.

9. The fishing lure of claim 8, wherein the connector connects to the shank at multiple points.

10. The fishing lure of claim 1, further comprising:
a grommet inserted in the accessory inlet.

11. A fishing lure comprising;
a corrugated sheet including at least one peak and a plurality of troughs, wherein a first peak of the at least one peak is between a first trough and a second trough and the plurality of troughs, wherein the corrugated sheet defines a first line inlet and defines a second line inlet between the first trough and the second trough, wherein the corrugated sheet further defines an accessory inlet, wherein the first trough is between the accessory inlet and the first peak in a first direction;
an accessory attached to the corrugated sheet via the accessory inlet; and
a hook attached to the accessory.

12. The fishing lure of claim 11 further comprising:
a line-tie connector attached to the corrugated sheet through the first line inlet and the second line inlet.

13. The fishing lure of claim 12, wherein the line-tie connector is attached to the corrugated sheet such that the line tie connector is capable of rotating at least 170 degrees relative to the corrugated sheet in a plane perpendicular to the first direction.

14. The fishing lure of claim 11, wherein each of the at least one peak is a local maximum in a second direction perpendicular to the first direction, and each of the at least one trough is a local minimum in the second direction.

15. The fishing lure of claim 14, wherein the corrugated sheet includes a first sloped portion and a second sloped portion, wherein one of the at least one peak is between the first sloped portion and the second sloped portion, wherein the first sloped portion has a positive slope relative to the first and second directions and the second sloped portion has a negative slope relative to the first and second directions.

16. The fishing lure of claim 15, wherein the first sloped portion defines the first line inlet and the second sloped portion defines the second line inlet.

17. The fishing lure of claim 16, wherein the first line inlet and second line inlet are arranged and sized such that a line-tie connector attached to the corrugated sheet via the first line inlet and second line inlet is capable of rotating at least 170 degrees relative to the corrugated sheet in a plane perpendicular to the first direction.

18. The fishing lure of claim 11, wherein the accessory includes a shank and a connector, wherein the shank is attached to the corrugated sheet via the connector, and wherein the connector is configured to rotate around the shank.

19. The fishing lure of claim 18, wherein the connector connects to the shank at multiple points.

20. The fishing lure of claim 11, further comprising:
a grommet inserted in the accessory inlet.
